(19) United States
(12) Patent Application Publication
(10) Pub. No.: US 2019/0291163 A1
(43) Pub. Date: Sep. 26, 2019

(54) SPRINGBACK COMPENSATION IN THE PRODUCTION OF FORMED SHEET-METAL PARTS

(71) Applicant: Inigence GmbH, Bretzfeld (DE)

(72) Inventors: Arndt Birkert, Bretzfeld (DE); Stefan Haage, Weingarten (DE); Markus Straub, Obersulm (DE); Benjamin Hartmann, Tauberbischofsheim (DE)

(21) Appl. No.: 16/317,337

(22) PCT Filed: Jul. 7, 2017
(86) PCT No.: PCT/EP2017/067141

§ 371 Date: Jan. 11, 2019

(30) Foreign Application Priority Data
Jul. 14, 2016 (DE) 10 2016 212 933.3

(51) Int. Cl. B21D 37/20; B21D 22/26

(52) U.S. Cl. CPC B21D 37/20; G06F 17/5018; B21D 22/26

(57) ABSTRACT

A method of producing a forming tool for producing a complex formed part with a target geometry by performing a drawing type of forming pro cess on a workpiece, wherein the forming tool has an active surface that engages the workpiece to be formed including determining an active-surface geometry specification for the active surface; and producing the active surface according to the active-surface geometry specification.

### TECHNICAL FIELD

This disclosure relates to a method of determining an active surface of a forming tool for producing a complex formed part with a target geometry by performing a drawing type of forming process on a workpiece, a method of producing a forming tool, a method of producing a complex formed part and also a computer program product.

### BACKGROUND

Formed parts of sheet metal, in particular parts of the bodywork for vehicles, are generally produced by a drawing technique, for example, deep drawing or bodywork pressing. For this, the semifinished product, known as a sheet blank, is placed into a multipart forming tool. By a press, in which the forming tool is clamped, the formed part is formed. The finished formed parts are generally produced from flat sheet blanks by a number of forming stages such as drawing, restriking, adjusting and the like combined with trimming steps.

The tool production of a forming tool typically proceeds in numerous stages. A comprehensive description can be found in: A. Birkert, S. Haage, M. Straub: “Umformtechnische Herstellung komplexer Karosserieteile—Auslegung von Ziehanlagen” (production of complex bodywork parts by forming techniques—design of drawing installations), Springer Vieweg-Verlag (2013) Chapter 5.9. By the stage of initially using and trying out the tool, a forming tool that is fundamentally functional is produced. This is followed by the stage of tool correction with regard to accuracy of the dimensions and shape. This tool correction includes all measures performed on the fundamentally functional tool to ensure not only that production can be carried out without any rupturing or wrinkling but also that accurately dimensioned and shaped parts are produced.

The corrections to be carried out in the course of the so-called tryout phase are required because it is virtually impossible to produce complex drawn parts within the prescribed tolerances right away. Dimensional deviations on the first part from the actual production mold have various causes, both with respect to the absolute position and variation of the measurement results over a number of parts. One of the main causes are dimensional deviations as a consequence of the elastic springback of the parts after the opening of the tool, or after removal from the tool.

The elastic springback of the formed part is so far one of the main factors driving up costs. For instance, in tool construction, considerable proportions of the overall costs are today expended on compensating for the geometrical deviations produced by springback.

There are various correction strategies to eliminate dimensional and shape-related deviations on a pressed part by changing the geometry or shape of the actual tool geometry depicting the pressed part (on the basis of a fundamentally functional tool) to the extent that the workpiece resulting from the forming process has the desired target geometry within the tolerances. This target geometry is also referred to as the “zero geometry” of the workpiece. The following definitions apply:

“Zero geometry” means the geometry of the workpiece intended to be achieved in the stage of the operation concerned. A forming tool modeled on the CAD preset geometry of the workpiece to be produced (i.e., the zero geometry) is referred to as the “zero tool.” In such a (non-compensated) tool, the tool zero geometry and the workpiece zero geometry are identical. “Correction geometry” is to be understood as meaning the corrected, that is to say, for example, overbent tool geometry. This necessarily deviates from the zero geometry to be achieved in the stage concerned (i.e., the target geometry of the workpiece) since springback is assumed after opening the tool. “Springback geometry” is refers to the workpiece geometry obtained after opening the tool. The springback geometry should therefore correspond to the target geometry after the last operation of the zero geometry of the component. Correction strategies should therefore be created such that, by producing suitable correction geometries on the forming tool, the production of a component in zero geometry is made possible. A tool with correction geometry is generally referred to as a “compensated tool” so that the correction geometry may also be referred to as “compensation geometry.”

The correction method mostly used nowadays is the method of inverse vectors. In,for example, W. Gan, R. H. Wagoner: “Die design method for sheet springback,” International Journal of Mechanical Sciences 46 (2004), pages 1097-1113, this is also referred to as the displacement adjustment method (DA method). The term “inverse vector” results from compensation algorithms for springback compensation such as are used today in a strict or modified form in commercially available FEM software for the simulation of sheet forming processes. One example is the commercially available simulation software “AUTOFORM®” of Autoform Engineering GmbH, Neerach (CH).

On the basis of available geometry data at the end of the last operation before opening the tool and the corresponding geometry data after opening the tool (that is to say after calculation of the springback) a displacement vector can be calculated for each individual element node. A precondition for this is that node equality is ensured in the last calculating step, that is to say in the springback calculation. Node equality means that each node in the part still subject to the loading of the tool can be uniquely assigned a node in the part not subject to loading, that is to say the sprungback part. Consequently, the displacement field in combination with the zero geometry prescribed, for example, by a CAD data record gives the extent of the springback. If it is then desired to correct this springback, the forming surfaces of the correction geometry can be produced in a strict form in accordance with that algorithm in that the displacement field is applied to the zero geometry in the reverse direction. “Strictly” means that the vectors are actually inverted mathematically correctly. That procedure generally leads to correction geometries of sufficiently equal surface area in small to moderate geometry deviations. In greater springbacks, certain area errors between the correction geometry and the zero geometry have to be accepted.

With a “simple” inversion of the displacement vectors between the zero geometry and the springback geometry, a geometrical error may occur. X. Yang, F. Ruan: “A die design method for springback compensation based on displacement adjustment,” International Journal of Mechanical Sciences (2011), presents a procedure (comprehensive compensation (CC) method) intended to make it possible to mitigate the problem. The approach of the CC method is to change the direction of the inverted displacement vectors (compared to the DA method) in accordance with certain geometrical criteria.

DE 10 2005 044 197 A1 describes a method for the springback-compensated production of formed sheet-metal parts with a forming tool in which parameterized tool meshes of the active surfaces of the forming tool are produced from a three-dimensional CAD model of the forming tool, in an iterative process with the aid of the parameterized tool meshes a simulation of the forming process, a simulation of the springback of the formed sheet-metal part, a determination of causes of the springback and a modification of mesh parameters of the parameterized tool meshes derived from the causes of the springback and/or of process parameters of the forming process to compensate for the springback of the formed sheet-metal part are performed, after the iterative process the modified mesh parameters of the parameterized modified tool meshes are used to derive geometrical parameters with which the modifications of the tool meshes are transferred to the CAD model, a springback-compensating forming tool is produced and/or adapted in accordance with the prescription of the modified CAD model and—the formed sheet-metal part is formed with the springback-compensating forming tool, the modified process parameters being set.

It could therefore be helpful to provide a method which, while retaining the advantages of conventional methods, makes it possible to produce forming tools with compensation geometries created such that the components produced with them are to the greatest extent equal in surface area, or are equal in surface area to the zero geometry desired for the component even in relatively great springback.

A problem that the conventional DA method entails is that—depending on the basic component geometry and the amount of springback—the correction/compensation geometry thus produced deviates in its area content from the area content of the zero geometry both from region to region and globally. That is to say that, both in the simulation and in reality, the workpiece as it is in the compensated tool at the end of the forming operation has a different surface area content than the zero geometry. Consequently, by that method, which represents the state of the art, after springback a workpiece can virtually never completely assume the desired zero geometry because, for this, local and regional component geometry features would have to be plastically deformed solely on the basis of the elastic energy stored in the workpiece such that, at the end, area equality prevails locally, regionally and globally, which is simply not possible for physical reasons. In practice, there are inter alia these area deviations between the corrected geometry and zero geometry, which in tool construction lead to a number of iteration loops in the reworking of the tool to bring a component into the intended tolerance range. Particular difficulties also arise especially in multi-stage processes because parts from one operation are not suitable at all for the following operation.

### SUMMARY

We thus provide:
A method of determining an active surface of a forming tool for producing a complex formed part with a target geometry by performing a drawing type of forming process on a workpiece including simulating a forming operation on the workpiece by a zero tool (NWZ) to produce a first configuration (K1) of the workpiece (W), the zero tool representing a forming tool having an active surface geometry corresponding to a desired target geometry of the workpiece; simulating an elastic springback of the workpiece from the first configuration (K1) into a second configuration (K2) that is largely free of external forces, the simulation being performed based on an elastic-plastic material model of the workpiece; calculating a deviation vector field with deviation vectors (ABV) between the first configuration (K1) and the second configuration (K2); carrying out a non-linear structural-mechanical finite-element simulation on the workpiece, the workpiece being deformed by the non-linear structural-mechanical finite-element simulation from the first configuration or the second configuration into a target configuration by using deviation vectors (ABV) of the deviation vector field, wherein the following steps being carried out in the non-linear structural-mechanical finite-element simulation defining at least three fixing points (FIX1, FIX2, FIX3, FIX4) of the first configuration or the second configuration, the fixing points intended to remain unchanged with respect to their position during the non-linear structural-mechanical finite-element simulation; fixing the first configuration (K1) or the second configuration (K2) at the fixing points; approximating the configuration of the workpiece to the target configuration outside the fixing points by calculating forces or displacements while accounting for the stiffness of the workpiece until the target configuration is achieved; and specifying the achieved target configuration as the active surface for the forming tool.

A method of producing a forming tool for producing a complex formed part with a target geometry by performing a drawing type of forming process on a workpiece, wherein the forming tool has an active surface that engages the workpiece to be formed including determining an active-surface geometry specification for the active surface according to the method of determining an active surface of a forming tool for producing a complex formed part with a target geometry by performing a drawing type of forming process on a workpiece including simulating a forming operation on the workpiece by a zero tool (NWZ) to produce a first configuration (K1) of the workpiece (W), the zero tool representing a forming tool having an active surface geometry corresponding to a desired target geometry of the workpiece; simulating an elastic springback of the workpiece from the first configuration (K1) into a second configuration (K2) that is largely free of external forces, the simulation being performed based on an elastic-plastic material model of the workpiece; calculating a deviation vector field with deviation vectors (ABV) between the first configuration (K1) and the second configuration (K2); carrying out a non-linear structural-mechanical finite-element simulation on the workpiece, the workpiece being deformed by the non-linear structural-mechanical finite-element simulation from the first configuration or the second configuration into a target configuration by using deviation vectors (ABV) of the deviation vector field, wherein the following steps being carried out in the non-linear structural-mechanical finite-element simulation defining at least three fixing points (FIX1, FIX2, FIX3, FIX4) of the first configuration or the second configuration, the fixing points intended to remain unchanged with respect to their position during the non-linear structural-mechanical finite-element simulation; fixing the first configuration (K1) or the second configuration (K2) at the fixing points; approximating the configuration of the workpiece to the target configuration outside the fixing points by calculating forces or displacements while accounting for the stiffness of the workpiece until the target configuration is achieved; and specifying the achieved target configuration as the active surface for the forming tool; and producing the active surface according to the active-surface geometry specification.
A method of producing a complex formed part with a target geometry by performing a drawing type of forming process on a workpiece by using a forming tool having an active surface that engages the workpiece to be formed, including producing a forming tool according to the method of determining an active surface of a forming tool for producing a complex formed part with a target geometry by performing a drawing type of forming process on a workpiece including simulating a forming operation on the workpiece by a zero tool (NWZ) to produce a first configuration (K1) of the workpiece (W), the zero tool representing a forming tool having an active surface geometry corresponding to a desired target geometry of the workpiece; simulating an elastic springback of the workpiece from the first configuration (K1) into a second configuration (K2) that is largely free of external forces, the simulation being performed based on an elastic-plastic material model of the workpiece; calculating a deviation vector field with deviation vectors (ABV) between the first configuration (K1) and the second configuration (K2); carrying out a non-linear structural-mechanical finite-element simulation on the workpiece, the workpiece being deformed by the non-linear structural-mechanical finite-element simulation from the first configuration or the second configuration into a target configuration by using deviation vectors (ABV) of the deviation vector field, wherein the following steps being carried out in the non-linear structural-mechanical finite-element simulation defining at least three fixing points (FIX1, FIX2, FIX3, FIX4) of the first configuration or the second configuration, the fixing points intended to remain unchanged with respect to their position during the non-linear structural-mechanical finite-element simulation; fixing the first configuration (K1) or the second configuration (K2) at the fixing points; approximating the configuration of the workpiece to the target configuration outside the fixing points by calculating forces or displacements while accounting for the stiffness of the workpiece until the target configuration is achieved; and specifying the achieved target configuration as the active surface for the forming tool.
A non-transitory computer program product stored on a computer-readable medium or realized as a signal, the computer program product, when it is loaded into the memory of a suitable computer and executed by a computer, having the effect that the computer carries out the method of determining an active surface of a forming tool for producing a complex formed part with a target geometry by performing a drawing type of forming process on a workpiece including simulating a forming operation on the workpiece by a zero tool (NWZ) to produce a first configuration (K1) of the workpiece (W), the zero tool representing a forming tool having an active surface geometry corresponding to a desired target geometry of the workpiece; simulating an elastic springback of the workpiece from the first configuration (K1) into a second configuration (K2) that is largely free of external forces, the simulation being performed based on an elastic-plastic material model of the workpiece; calculating a deviation vector field with deviation vectors (ABV) between the first configuration (K1) and the second configuration (K2); carrying out a non-linear structural-mechanical finite-element simulation on the workpiece, the workpiece being deformed by the non-linear structural-mechanical finite-element simulation from the first configuration or the second configuration into a target configuration by using deviation vectors (ABV) of the deviation vector field, wherein the following steps being carried out in the non-linear structural-mechanical finite-element simulation defining at least three fixing points (FIX1, FIX2, FIX3, FIX4) of the first configuration or the second configuration, the fixing points intended to remain unchanged with respect to their position during the non-linear structural-mechanical finite-element simulation; fixing the first configuration (K1) or the second configuration (K2) at the fixing points; approximating the configuration of the workpiece to the target configuration outside the fixing points by calculating forces or displacements while accounting for the stiffness of the workpiece until the target configuration is achieved; and specifying the achieved target configuration as the active surface for the forming tool.

### BRIEF DESCRIPTION OF THE DRAWINGS

FIG. 1 shows a workpiece with a hate profile to be produced by performing a drawing type of forming process.

FIG. 2 shows a schematic representation explaining some of the terms used herein.

FIGS. 3 to 5 show various stages of a simulated forming process and how they relate to the zero geometry.

FIG. 6 shows a configuration after carrying out two further compensation loops.

FIG. 7 shows various regions of a finished component with local deviations between the final geometry achieved with the aid of a conventional DA method and the desired target geometry after three compensation loops.

FIG. 8 shows the changes of the component geometry achieved after various iteration stages.

FIGS. 9A and 9B show graphic representations to illustrate aspects of a non-linear structural-mechanical finite-element simulation.

FIGS. 10A-10C show various possibilities for the effect of forces acting in a force-based simulation.

FIGS. 11A and 11B show by way of example the positioning of fixing points for a non-linear structural-mechanical finite-element simulation in the example of a workpiece in the form of an A pillar (FIG. 11A) and a schematic sectional representation along the line A-A in FIG. 11A (FIG. 11B).

FIGS. 12A and 12B show possibilities for the definition of the position of fixing points on a workpiece with a hat profile.

FIGS. 13A-13C show by way of illustration the use of supporting elements for the definition of a third configuration, serving as a target configuration in a force-based simulation.

FIG. 14 shows, for the purpose of a direct comparison with FIG. 15, the result of the conventional DA method according to FIG. 5.

FIG. 15 shows for comparison with FIG. 14 the result of a force-based simulation according to an example.

FIG. 16 shows by analogy with FIG. 7 the local deviations between a final geometry achieved and the target geometry at different regions of a workpiece after carrying out two compensation loops according to a force-based simulation.

FIG. 17 shows a possible node displacement field of the springback and also a node-based inverse vector field similar to FIG. 2.

FIG. 18 shows the determination of normal deviation vectors in an example of a displacement-based simulation.

FIG. 19 schematically shows local systems of coordinates oriented on normal deviation vectors in a displacement-based simulation.

FIG. 20 shows the derivation of first components of target displacement vectors from normal displacement vectors in a displacement-based simulation.

FIG. 21 illustrates the determination of second and third components of a target displacement vector in a displacement-based simulation.

FIG. 22 schematically shows a comparison between a part of a hat profile that has been produced according to a conventional DA method and according to a displacement-based simulation.

### DETAILED DESCRIPTION

We provide a method of determining an active surface of a forming tool intended to be suitable for producing a complex formed part. The desired form of the complex formed part after completion of the forming may be defined by a target geometry. For the forming, a drawing type of forming method is used, for example, deep drawing. The determination of the active surface is performed in a computer-based manner with the aid of simulation calculations. By analogy with the conventional DA method, first a forming operation on the workpiece is simulated by a zero tool to produce computationally a first configuration of the tool. The term “first configuration” consequently describes the zero geometry of the workpiece mentioned at the beginning. The “zero tool” in this example represents a forming tool having an active surface or active surface geometry corresponding to the desired target geometry of the workpiece. Based on the results of this forming operation, subsequently an elastic springback of the workpiece from the produced first configuration into a second configuration largely free from external forces is simulated. “Largely free” means that the influence of gravitational force should be taken into account in the simulation. A free springback (without taking into account the influence of gravitational force) should also be included as the limiting case of the formulation “largely free.” This simulation of the springback is performed on the basis of an elastic-plastic material model of the workpiece from which the springback properties are derived. The “second configuration” consequently corresponds to the springback geometry of the workpiece mentioned at the beginning.

Once the first and second configurations have been determined, there follows the calculation of a deviation vector field with deviation vectors between the first and second configurations. With the aid of the deviation vector field, the geometrical difference between the first and second configurations can be quantitatively described. The deviation vector field may also be referred to as the displacement vector field for the springback.

One important consideration is that different deviation vector fields can be used in the course of our methods. One possibility is to describe each of the first configuration and the second configurations by a finite element mesh and to determine the deviation vectors between mesh nodes of the first configuration and assigned mesh nodes of the second configuration. This is not imperative however. Suitable deviation vector fields can also be defined without using mesh nodes between other points assigned to one another of the first and second configurations. In particular, deviation vectors orthogonal to the first configuration or the surface area described by it may be used.

An important step of the method is that of carrying out a non-linear structural-mechanical finite-element simulation on the workpiece. In the course of this simulation, the workpiece is deformed from the first or second configuration into a target configuration by using the aforementioned deviation vectors of the deviation vector field. The non-linear structural-mechanical finite-element simulation comprises inter alia the step of defining at least three fixing points of the first or second configuration. A “fixing point” remains unchanged with respect to its position during the non-linear structural-mechanical finite-element simulation. Fixing points are therefore spatially invariant under the non-linear structural-mechanical finite-element simulation. The first or second configuration is then fixed at the fixing points. In an actual forming operation, the fixing step can be compared to a fixed-point mounting of the first or second configuration or a correspondingly designed workpiece.

This is followed by an approximation of the configuration of the workpiece to the target configuration in regions outside the fixing points with the aid of the calculation of forces or displacements while taking into account the stiffness of the workpiece until the target configuration is achieved. The achieved target configuration is then specified as the active surface for the forming tool. The shape of the active surface can be described by an active-surface geometry specification. The target configuration describes the correction geometry of the workpiece after carrying out the method. The corresponding forming tool of which the active surface is designed according to the target configuration may be referred to as the compensated forming tool.

An important aspect of this approach to a solution is that the correction geometry is not produced just by strict geometrical inversion of a deviation vector field (purely geometrical compensation), but including not only the workpiece geometry but also the mechanical behavior of the workpiece in the calculation of the compensation geometry when producing the compensation geometry. This is achieved by taking into account the stiffness of the workpiece. The non-linear finite element method (non-linear FEM) is used as the numerical tool for this. With this numerical tool, both solution approaches based on elasticity theory and solution approaches based on plasticity theory of the continuum mechanics can be simplified and, consequently, calculated as an approximation. The relationship between forces and displacements is computationally established quite generally by the stiffness (or stiffness of the workpiece) not only in the continuum and in the discretized overall structure but also in the individual element. The stiffness describes the load-deformation behavior of an element or a body. A comprehensive description of basic principles of the non-linear finite element method can be found in: W. Rust: “Nichtlineare Finite-Elemente-Berechnungen” (non-linear finite element calculations), Vieweg+Teubner Verlag (2009) page 21 ff. Details on how it is used are explained in connection with the examples.

For the step of defining fixing points, it is provided in preferred examples that first a regional or global adaptation region in which an adaptation between the first and second configurations is to be performed is selected. Then, without changing the respective shape, the first and second configurations are aligned in relation to one another such that in the selected adaptation region there is a minimal geometrical deviation between the first and second configurations in accordance with a deviation criterion. This assimilation to one another of the first and second configurations may be performed, for example, by using the method of least squares in the adaptation region. After completion of the adaptation, positions with a local minimum of a deviation between the first and second configurations are computationally determined and the at least three fixing points are defined at at least three selected positions with a local minimum of the deviation. For example, it may be that, after carrying out the adaptation, the first and second configurations or the surface areas defined by them cross over or intersect along straight or curved sectional lines. Each position on a sectional line may come into consideration as a position for a fixing point since the distance there between each of the first and second configurations equal to zero. Fixing points may also be provided at positions at which, after the adaptation calculation, there remains a distance that is a small as possible, but finite.

The size and shape of the adaptation region within which the assimilation is to be performed may vary, for example, in dependence on the component geometry (for example, complexity of the shape), and be chosen correspondingly. It may be that the adaptation region comprises the overall surface area of the workpiece. This is referred to here as the “global adaptation region” or global adaptation. It is also possible that the adaptation region only comprises a partial region of an overall surface area of the workpiece. This is referred to here as the “regional adaptation region” or regional adaptation.

Preferably, positions of fixing points are selected such that the fixing points form at least a triangular arrangement. In a triangular arrangement, an overdetermination of the “mounting” or fixing of the components for carrying out the subsequent virtual deformations can be avoided. If required, for example, if a triangular arrangement does not appear to be sufficiently stable, at least one further fixing point may be used. For example, four, five or six fixing points may be defined at suitable distances from one another. Also then, an overdetermination of the fixing should be avoided.

In the non-linear structural-mechanical finite-element simulation, the configuration of the workpiece is computationally approximated to the target configuration, while taking into account, inter alia, the stiffness of the workpiece in the calculations. The stiffness may, for example, be parameterized by a stiffness matrix. In this example, preferably either a calculation of forces or a calculation of displacements is respectively carried out while taking into account the stiffness of the workpiece. These different variants are also referred to as “force-based simulation” and “displacement-based simulation.” Preferred variants are explained below.

In a preferred variant of a force-based simulation, that is to say a calculation taking forces into account, the calculation of the deviation vector field is carried out such that deviation vectors between mesh nodes of the first configuration and assigned mesh nodes of the second configuration are calculated. The deviation vector field may in this example also be referred to as the “node displacement field.” On the basis of the deviation vector field thus determined, a third configuration inverse to the second configuration is then calculated. In this example, correction vectors are calculated from the deviation vectors by geometrical inversion with respect to the first configuration, and the third configuration is calculated by applying the correction vectors to mesh nodes of the first configuration. The “third configuration” thus determined consequently describes an inverse geometry in relation to the springback geometry, and to this extent corresponds to the correction geometry from the conventional method of inverse vectors.

While in the conventional DA method this correction geometry can represent the end result, in the method variant described here the third configuration is used as a target description for the approximation or as a reference point for the compensation surface area to be found. In the method variant, deformation forces are computationally introduced into the workpiece in at least one force introduction region lying outside a fixing point to approximate the configuration of the workpiece to the third configuration. The deformation forces may be point forces, line forces and/or area forces. Deformations of the workpiece under the effect of the deformation forces are determined by the non-linear structural-mechanical finite-element simulation while taking into account the stiffness of the workpiece. In other words: the resistance of the workpiece to the deformation is computationally taken into account in the simulation. The deformation forces are varied with regard to strength, direction, location of the introduction of the force and/or possible further parameters, until the target configuration is achieved under elastic deformation of the workpiece. The achieved target configuration is then specified as the active surface for the forming tool. In this method variant, a node-based inverse vector field (node displacement in space analogous to the conventional DA method) therefore serves as the target geometry (third configuration).

A particularly quick and resource-saving calculation is achieved in a method variant in that the third configuration is defined by a supporting element grid with a multiplicity of (virtual) supporting elements lying at a distance from one another, each supporting element representing a position on the target configuration (third configuration). The supporting elements may serve as virtual “stops” in the virtual deformation. The approximation of the configuration to the third configuration can then be simulated by a simultaneous or sequential introduction of force at different force introduction regions until the configuration is lying against a multiplicity of supporting elements under elastic deformation. The target configuration does not necessarily have to have “contact” with all of the supporting elements, there may also be a remaining distance in some individual supporting elements.

As an alternative to a force-based simulation, a displacement-based simulation may be carried out, functioning without forces being prescribed—by displacements being prescribed. In this method variant, the deviation vector field with the deviation vectors between the first and second configurations is calculated such that each deviation vector is a normal deviation vector, that is to say a vector which at a selected location of the first configuration is perpendicular to the first surface area defined by the first configuration at the selected location and connects the selected location to an assigned location of the second configuration. The deviation vector field is therefore a vector field perpendicular to the zero geometry that takes the springback into account. On this basis, a calculation of a target displacement vector field is performed with a multiplicity of target displacement vectors, each target displacement vector connecting a selected location of the first configuration to an assigned location of the target configuration. The target displacement vectors consequently specify the target geometry to be achieved from the first configuration (zero geometry of the workpiece). In this example, first components of the target displacement vectors are prescribed by geometrical inversion of normal deviation vectors of the deviation vector field with respect to the first configuration. These first components are consequently perpendicular to the first configuration. The second component and the third component of the three-component target displacement vectors are then calculated on the basis of the first components by the non-linear structural-mechanical finite-element simulation while taking into account the stiffness of the tool. Consequently, inverted vectors are used here as a boundary condition within the FEM simulation.

In this method variant there are various possibilities of defining or calculating the normal deviation vectors. In one variant, the normal deviation vector may be described as that component of a “node displacement vector” perpendicular to the first configuration. Then, the abovementioned “selected location” is a mesh node of the FEM mesh. In another variant, the calculation of the normal deviation vectors is performed independently of mesh nodes so that a normal deviation vector can also have its origin outside a mesh node of the FEM simulation.

There are consequently two alternative possibilities for the step of approximating the configuration of the workpiece to the target configuration outside the fixing points, to be specific on the one hand by calculation of forces and on the other hand by calculation of displacements. Each of these calculation steps are carried out while taking into account the stiffness of the workpiece until the target configuration is achieved.

According to another general formulation, another way of stating this aspect is by saying that the approximation step is performed in that in the structural-mechanical finite-element simulation there is a virtual application of force, by which the workpiece is deformed into a compensation geometry in a way corresponding to the inverted deviation vector field, or in that in the structural-mechanical finite-element simulation displacements that correspond to the inverted deviation vector field are defined as boundary conditions.

It must be noted here which deviation vector field is inverted and that the displacement boundary conditions may only be defined in one direction of a system of coordinates.

According to a more precise formulation, another way of stating this aspect is consequently the approximation step is performed in that in the structural-mechanical finite-element simulation there is a virtual application of force, by which the workpiece is not strictly deformed into a compensation geometry, but is only deformed as an approximation with the inverted deviation vector field in the sense of allowing certain degrees of freedom, or in that in the structural-mechanical finite-element simulation displacements perpendicular to the surface of the zero geometry in only one axial direction of locally defined systems of coordinates corresponding to the deviation vector field inverted perpendicularly to the zero geometry are defined as boundary conditions.

Just using the method once may lead to considerably smaller deviations between the target geometry and the geometry that can be achieved with the aid of the compensated tool compared to the conventional DA method. If, according to one example, at least one further non-linear structural-mechanical finite-element simulation is carried out on the workpiece after completion of a first non-linear structural-mechanical finite element simulation by using the compensated forming tool with an active surface according to a previous non-linear structural-mechanical finite-element simulation, that is to say at least one further iteration step, the deviations can be reduced further. A single further iteration may be sufficient to obtain an active surface having the effect when used in practical forming operation that the achieved geometry of the formed workpiece coincides with the target geometry within tolerances.

The working result of the method is an active surface for the forming tool or an active-surface geometry specification describing the active surface. We also provide a method of producing a forming tool suitable for producing a complex formed part with a target geometry by performing a drawing type of forming process on a workpiece, the forming tool having an active surface that engages the workpiece to be formed. In this method of producing a forming tool, an active-surface geometry specification or the active surface is determined according to the computer-based method and the active surface of the actual forming tool is produced on the actual forming tool according to the active-surface geometry specification.

We further provide a method of producing a complex formed part with a target geometry by performing a drawing type of forming process on a workpiece by using a forming tool having an active surface that engages the workpiece to be formed, a forming tool produced on the basis of the computer-based method or according to the aforementioned method of producing a forming tool being used.

The capability of executing examples and configurations may be implemented in the form of additional program parts or program modules or in the form of a program amendment in simulation software using the method of inverse vectors. Therefore, we provide a computer program product that is in particular stored on a computer-readable medium or realized as a signal, the computer program product, when it is loaded into the memory of a suitable computer and executed by a computer, having the effect that the computer carries out our method or a preferred example thereof.

A number of examples explaining possibilities for the practical implementation of our methods and computer program products are explained below. The methods serve for the computer-aided, simulation-based determination of an active surface or an active surface geometry of an actual forming tool to be used to produce a complex formed part by performing a drawing type of forming process on a workpiece. For this, the geometry of the active surface of a virtual forming tool is calculated by simulation. The virtual active surface or its geometry then serves as a prescription or specification for the production of the active surface of the actual forming tool.

The desired form or shape of the workpiece after completion of the forming operation may be prescribed by a target geometry. The methods presented are aimed at a geometrical compensation of the springback of the actual workpiece while taking into account the stiffness of the component, that is to say the stiffness of the workpiece. The overbending required to achieve a suitable correction geometry of the active surface is calculated by a static-mechanical finite-element simulation (FEM simulation). This retains in principle the known fundamental idea of changing the tool geometry by the amount of the springback in the opposite direction, as a partial step. Unlike in known approaches, the correction geometry is however determined by a physical approach. Here, both the component geometry and the component stiffness are taken into account. As a result, significant improvements of the achievable workpiece geometry with regard to area equality or development equality of the correction geometry in relation to the desired target geometry can be achieved compared to known approaches. The following examples illustrate different approaches.

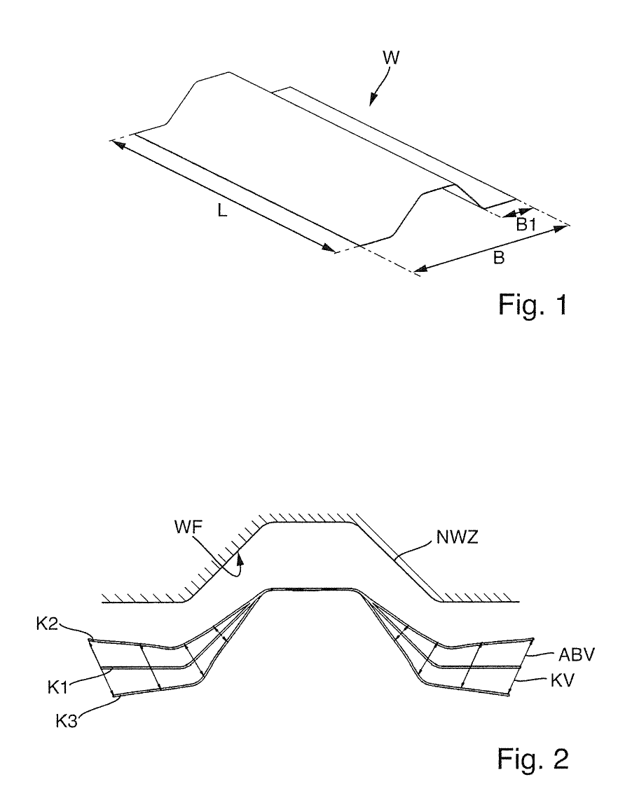

Many of the simulation-based investigations were performed on a relatively simple workpiece geometry in the form of a hat profile W according to FIG. 1. The starting workpiece, a planar metal sheet of a high-strength steel material with material designation HDT1200M and with a sheet thickness of 1 mm was used. With an overall length L=400 mm, the finished bent hat profile is intended to have between its longitudinal edges a width B of 216.57 mm. The planar sub-portions each have a width B1 of 40 mm.

For comparison purposes, a forming process that simulates inter alia a drawing operation and also the springback of the workpiece was simulated with the aid of the FE software AUTOFORM®.

For better comprehensibility, some of the terms are explained in more detail on the basis of FIG. 2. The desired target geometry of the finished formed part is also referred to as the zero geometry of the workpiece. In this application, it is also referred to as the first configuration K1 of the workpiece. A forming tool WZ of which the active surface WF that serves for the forming has the same geometrical shape as the zero geometry (first configuration) of the workpiece is referred to here as the zero tool NWZ. If the starting workpiece (sheet blank) is deformed with the aid of the zero tool NWZ, the deformed sheet assumes the zero geometry and, consequently, the first geometry K1 while the tool is still closed. In the simulation, this corresponds to a first forming operation on the workpiece by the zero tool NWZ to produce the first configuration K1 of the workpiece.

This configuration can only be maintained on the actual component while the tool is closed, and is lost due to elastic springback when the tool is opened. In technical terms of the simulation, an elastic springback of the workpiece from the first configuration into a second configuration K2 that is largely free of external forces is simulated. This simulation is based on an elastic-plastic material model of the workpiece that incorporates certain material properties, for example, the yield curve, the yield locus curve, the modulus of elasticity and/or the Poisson ratio. The geometry that the workpiece assumes after the load is relieved, that is to say in the force-free state after the first forming operation, is referred to as the springback geometry and in technical terms of simulation is represented by the second configuration K2.

After that, a third configuration K3, inverse to the second configuration K2, is calculated. This method step may take place by analogy with the conventional method of inverse vectors (displacement-adjustment method or DA method). In this example, first deviation vectors ABV are calculated, leading from a mesh node of the first configuration K1 to the corresponding mesh node of the second configuration K2 obtained after the springback. The deviation vectors ABV belonging to the individual mesh nodes form a deviation vector field. From the deviation vectors, correction vectors KV are calculated by geometrical inversion with respect to the first configuration K1. Just like the associated deviation vectors, the correction vectors have their origin in a mesh node of the first configuration K1 and point in the opposite direction to the associated deviation vectors. The amount of the vector, that is to say its length, is each generally preserved. It is also possible to multiply the lengths (amounts) of the deviation vectors by a correction factor not equal to one, for example, by correction factors from 0.7 to 2.5. The configuration obtained by applying the correction vectors KV to the associated mesh nodes of the zero geometry (first configuration K1) is the third configuration K3, which is inverse to the second configuration K2 and results from using the DA method.

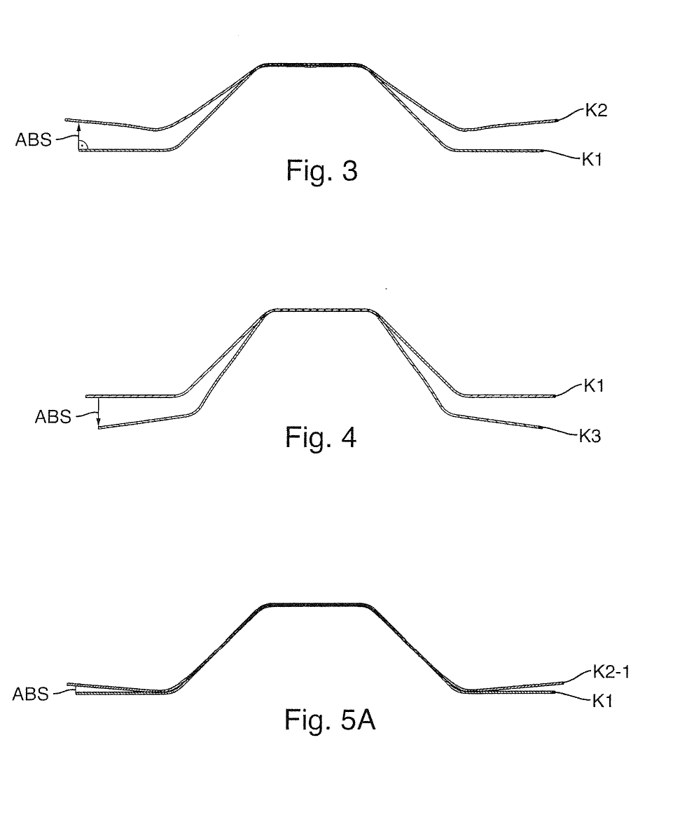

In the quantitative comparative example represented here, in technical terms of simulation the starting workpiece was deformed in a first forming operation with an (uncompensated) zero tool. For the quantification and assessment of the springback, in FIG. 3 the maximum perpendicular distance ABS in relation to the first configuration K1 (zero geometry) is shown on the left side. On account of the mirror symmetry of the workpiece, the same conditions are obtained on the right side. The distance ABS, measured in the direction normal to the first configuration, must not be confused with the deviation vector ABV, which connects associated mesh nodes of the first configuration and second configuration. In the example, the distance ABS was 13.8 mm.

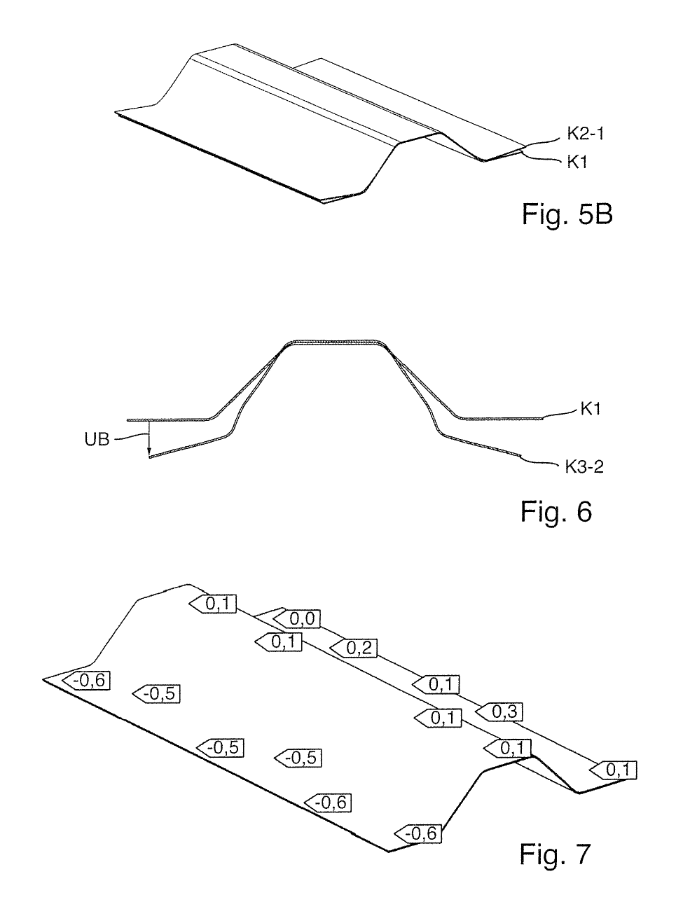

In the simulation carried out for comparative purposes, based on the method of inverse vectors (DA method), this was followed by a geometrical compensation of the active surfaces of the tool on the basis of a purely mathematical inversion of the deviation vector field, the directions being inverted and the amounts remaining unchanged. FIG. 4 shows the corresponding third configuration K3 that lies on the side of the first configuration K1 opposite the second configuration K2. If the workpiece is relieved of load after forming with this compensated tool, the springback configuration K2-1 shown in FIG. 5 is obtained after the first compensation loop on account of elastic springback. After the first compensation loop, the maximum perpendicular distance ABS in relation to the zero geometry (first configuration K1) is reduced from 13.8 mm to 4.2 mm.

It can already be seen well in FIG. 5A that the development length, measured in the widthwise direction, of the formed profile has increased with respect to the zero geometry so that the side edges of the formed profile running in the longitudinal direction lie further outward than in the zero geometry (first configuration K1). FIG. 5B likewise illustrates the conditions. The geometrical compensation by the displacement adjustment method resulted in a change in the development length by 2.36%, to be precise from 247.98 mm in the case of the zero geometry (first configuration K1) to 253.84 mm in the configuration K2-1 after springback.

On account of the still remaining error of about 4 mm in the maximum orthogonal distance ABS, two further compensation loops were run through in the simulation, whereby the correction geometry represented in FIG. 6 (third configuration K3-2) was obtained for the active surface of the forming tool. The overbending UB at the lateral edge of the component was then about 20 mm. After these three compensation loops, which are recommended as standard by the manufacturer of the simulation software AUTOFORM® virtually all of the regions of the component satisfied the shape-related and dimensional requirements typical in bodywork construction for connection surfaces and functional surfaces. These requirements are currently at about ±0.5 mm.

FIG. 7 shows for various regions of the finished component the locally available distances of the final geometry actually achieved in relation to the desired target geometry after three compensation loops.

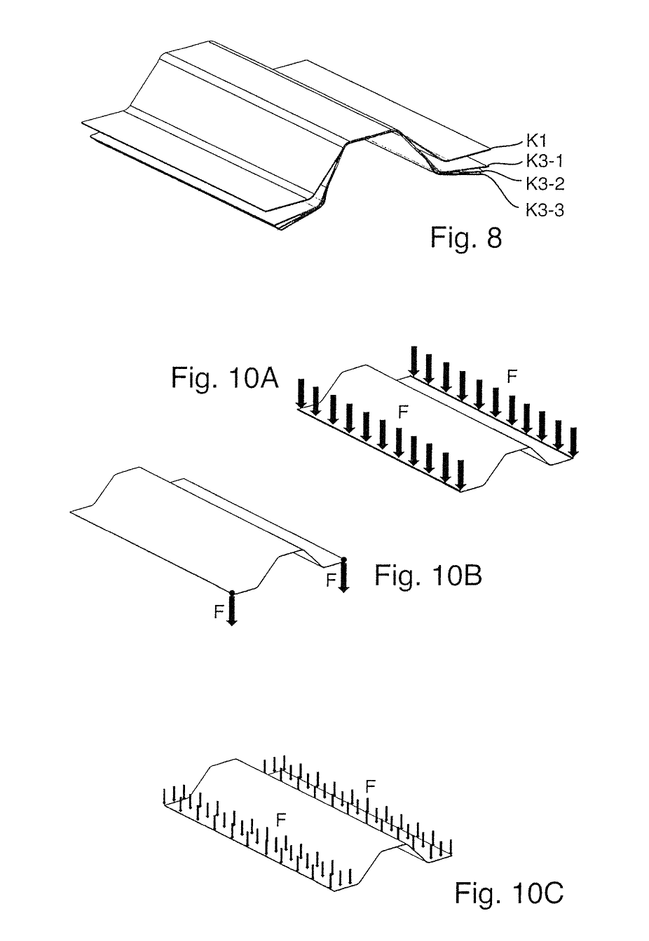

We found that the deviations of the development lengths became successively smaller over the various iterations or compensation loops. However, it was not possible for them to be eliminated completely. FIG. 8 illustrates the conditions graphically. In a development length of the first configuration K1 (zero geometry) of 247.98 mm, the development length of the third configuration K3-1 after the first compensation was 253.84 mm, after the second compensation loop (third configuration K3-2) was still 251.73 mm and after the third correction loop (third configuration K3-3) was still 249.57 mm. The percentage deviation of the development lengths of the correction geometries in relation to the zero geometry could therefore be reduced from about 2.4% through about 1.5% to approximately 0.6% percentage deviation.

Significant improvements in the direction toward area equality or development equality between the final geometry achieved in practice and the zero geometry (first configuration) can be achieved if a geometrical compensation of the springback is not exclusively performed purely geometrically but while taking into account the stiffness of the workpiece. On the basis of the following figures, two advantageous refinements of this procedure are explained.

In the two examples represented here, the calculation of deviation vectors and vectors inverse thereto is followed by a non-linear structural-mechanical finite-element simulation (NLSM-FEM simulation).

In a first principle of a refinement (force-based simulation), the first or second configuration (zero or springback geometry) is deformed within the non-linear structural-mechanical FE simulation into a correction geometry that lies within a prescribable tolerance range of the third configuration K3, that is to say the configuration that can be calculated by the method of inverse vectors.

In a second principle of a refinement (displacement-based simulation), the first configuration or second configuration (zero or springback geometry) is likewise deformed into a correction geometry, without however the necessity to take a tolerance range into account.

For better understanding, some aspects of the use of the NLSM-FEM simulation in the course of our methods are explained below. We recognized that it is possible with the aid of NLSM-FEM simulation to include not only the workpiece geometry but also the mechanical behavior of the workpiece in the calculation of the compensation geometry when producing the compensation geometry. This is achieved by taking into account the stiffness of the workpiece (stiffness for short). The non-linear finite element method is used as the numerical tool for this. The relationship between forces and displacements is computationally established quite generally by the stiffness not only in the continuum and in the discretized overall structure but also in the individual element. The stiffness describes the load-deformation behavior of an element or of a body. The force-displacement relationship of an overall structure is:

F=K·U (1)
where
F=column vector of all element node forces
K=structural stiffness matrix
U=column vector of all element node displacements.

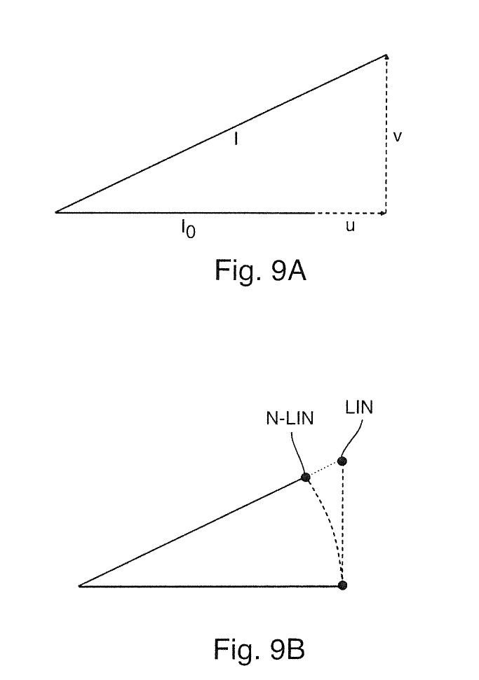

In the non-linear FEM, account is taken inter alia of geometrical non-linearities as a consequence of large rotations. For this, strains are described with the aid of Green-Lagrange strains. This derives from changing the square of the distance between two adjacent points. The related change of the squares 4 of the two lengths (deformed 1, undeformed 1₀) is (cf. FIG. 9A):

$$Δ = \frac{{I}^{2} - {I}_{0}^{2}}{{I}_{o}^{2}} = 2 \frac{u}{{I}_{o}} + {( \frac{u}{{I}_{o}} )}^{2} + {( \frac{v}{{I}_{o}} )}^{2} \to Δ = 2 \frac{du}{dx} + {( \frac{du}{dx} )}^{2} + {( \frac{dv}{dx} )}^{2} \qquad ( 2 )$$

$${ɛ}_{xx}^{non \text{-} linear} ɛ xx nichtliner = \frac{du}{dx} + \frac{1}{2} {( \frac{du}{dx} )}^{2} + \frac{1}{2} {( \frac{dv}{dx} )}^{2} \\ ( in the two dimensional ) \qquad ( 3 )$$

The influence of the variable εₓₓ^{non-linear} is represented in FIG. 9B by the point N-LIN. In small deformations, the squares become negligible, leaving only the first term.

$${ɛ}_{xx}^{linear} = \frac{du}{dx} \qquad ( 4 )$$

The influence of the negligible terms is represented by the point LIN in FIG. 9B. When linear FEM is used to produce a compensation geometry, development errors and area errors would occur in the same way as in the case of strict geometrical inversion. This is avoided by taking into account the square elements of the Green-Lagrange strain that ensure that rigid body rotations with any desired angles of rotation do not produce any strain.

In the derivation of the structural stiffness matrix K, the Green-Lagrange strain leads to an additional term, the stress matrix K_{σ}.

For a discretized mechanical problem, the equilibrium condition for the derivation of the structural stiffness matrix K is:

fᵢₙₜ(\vec{u})=fₑₓₜ(\vec{u})→d(\vec{u})=fᵢₙₜ(\vec{u})=fₑₓₜ(\vec{u})=0. (5)
where
fᵢₙₜ=internal node forces,
fₑₓₜ=external forces,
\vec{u}=displacement vector.

The stiffness matrix K as a derivative of the internal forces fᵢₙₜ is obtained in the general example as:

$$K = \frac{d}{d \vec{u}} \cdot {f}_{int} - \frac{d}{d \vec{u}} \cdot \underbrace{{f}_{ext} = {\int }_{( V )} {( \frac{d z}{d \vec{u}} )}^{T}}_{{K}_{u}} E \underbrace{( \frac{dz}{d \vec{u}} ) dV + {\int }_{( V )}}_{{K}_{σ}} \underbrace{\frac{{( \frac{dz}{d \vec{u}} )}^{T}}{d \vec{u}} σ d}_{{K}_{p}} V - \frac{dz}{d \vec{u}} {f}_{ext} \qquad ( 6 )$$

where
fᵢₙₜ=internal node forces,
fₑₓₜ=external forces,
\vec{u}=displacement vector,
ε=strain vector,
σ=stress vector,
E=elasticity matrix,
Kᵤ=displacement matrix,
K_{σ}=stress matrix,
K_{ρ}=load tangent.

The displacement matrix Kᵤ is formally very similar to the linear stiffness matrix. The stress matrix K_{σ} is sometimes also called the geometric matrix because only in the case of geometrical non-linearity is the derivation of the strain after the node displacements dependent on the displacements and, consequently, the derivative and K_{σ} exist.

Consequently, taking into account the stiffness of the workpiece by the stiffness matrix K as a function of the stress matrix K_{σ} when using non-linear FEM for area and development equality of the correction geometry can lead to the zero geometry.

To carry out the non-linear structural-mechanical finite-element simulation, three or more fixing points of the first configuration or the second configuration are defined. A fixing point is distinguished by the fact that in the non-linear structural-mechanical FE simulation it remains unchanged with respect to its position, that is to say does not undergo any change of its position in space. The first configuration or second configuration is fixed at the at least three fixing points so that their location coordinates do not change during the non-linear structural-mechanical finite-element simulation. The configuration of the workpiece is then approximated to the third configuration outside the fixing points until the target configuration is achieved. This approximation is performed with the aid of a calculation of forces or displacements while taking into account the stiffness of the workpiece, that is to say on the basis of a physical approach that goes beyond purely geometrical approaches. The target configuration achieved after this approximation is then specified as the active surface for the actual forming tool.

On the basis of FIGS. 10 to 16, first a more detailed explanation is given of a first example in which forces in the form of line loads (cf. FIG. 10A), point loads (cf. FIG. 10B) and/or area loads (cf. FIG. 10C) are simulatively applied to the configuration to be deformed. Either the zero geometry or springback geometry may be used as the starting geometry for the non-linear structural-mechanical FE simulation.

By way of the simulation to make possible an approximation of the configuration of the workpiece to the target configuration, the first configuration (zero geometry) and the second configuration (springback geometry) are suitably “mounted” to be precise at fixing points for the calculation of the overbending. The possible positions of fixing points are preferably specified on the basis of a best-fit alignment of the second configuration (springback geometry) in relation to the first configuration (zero geometry). For this, first a regional or global adaptation region, in which an adaptation between the first configuration and the second configuration is to be performed, is specified. After that, the first configuration and the second configuration are aligned in relation to one another such that in the adaptation region there is a minimal geometrical deviation between the first configuration and the second configuration in accordance with a deviation criterion. Preferably, the method of least squares is used for this in the adaptation region, whereby the first and second configurations are aligned in relation to one another to produce the smallest deviations in total by the method of least squares.

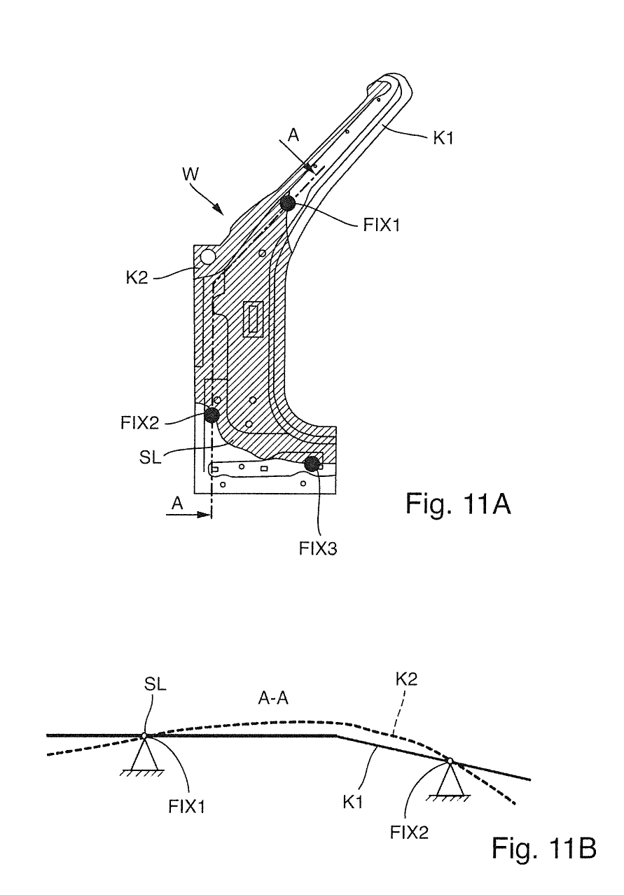

For illustration, FIG. 11A shows by way of example the positioning of fixing points for the non-linear structural-mechanical finite-element simulation in the example of a workpiece W in the form of an A pillar. In this complexly formed component, adaptation is performed over the entire component, which is referred to here as the global adaptation region. In the plan view in FIG. 11A, the hatched regions represent those regions in which the springback geometry (second configuration) lies closer to the observer than the zero geometry (first configuration) lying thereunder. In the non-hatched regions, on the other hand, the zero geometry (first configuration) lies closer to the observer. The situation can be seen well from the sectional representation in FIG. 11B. It can be seen that the springback geometry (second configuration K2) and the zero geometry (first configuration K1) cross over along zero crossings or sectional lines SL. All points on the sectional lines are consequently common to the zero geometry and the springback geometry. After the adaptation, they mark the regions of minimal geometrical deviation between the first configuration and the second configuration, the deviation being equal to zero here.

These regions of minimal geometrical deviation represent preferred locations for the positioning of fixing points. The positions of fixing points are thus preferably selected along the sectional lines such that at least a triangular arrangement with three fixing points FIX1, FIX2, FIX3 is obtained. By the use of three fixing points, a static overdetermination and a squeezing of the springback geometry can be avoided. The three fixing points are to define as large a triangle as possible to ensure a component position during the simulation that is as stable as possible. If a stable component position cannot be achieved by three fixing points, at least one further fixing point may be used. FIG. 11A shows one possible positioning of the fixing points for the non-linear structural-mechanical finite-element simulation.

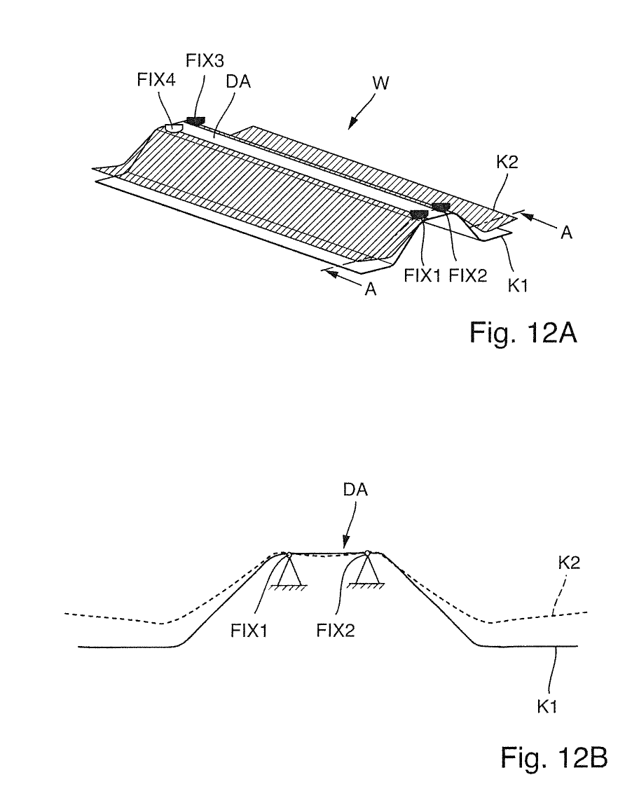

FIG. 12 shows another example of the definition of fixing points within non-linear structural-mechanical finite-element simulation. The workpiece W here is a hat profile having a mirror symmetry with respect to a mirror plane that runs centrally between the longitudinal edges perpendicular to the foot plane of the hat profile. In such symmetrically shaped components, it may be sufficient for the definition of fixing points only to select a segment of the overall area, that is to say a regional adaptation region that in this example lies symmetrically in relation to the plane of symmetry and only comprises the roof portion DA of the hat profile. As can be seen in the sectional representation of FIG. 12B, the zero geometry (first configuration K1) and the springback geometry (second configuration K2) intersect along two sectional lines running parallel to the longitudinal edges symmetrically in relation to the mirror plane. Altogether four fixing points are defined, the fixing points FIX1, FIX2 and FIX3 forming a triangular arrangement, and a further fixing point FIX4 being added as an auxiliary fixing point to maintain the mirror symmetry and stability.

The adaptation region should be chosen such that, in the following virtual deformation, for the sake of simplicity the forces only act on the workpiece respectively from one side.

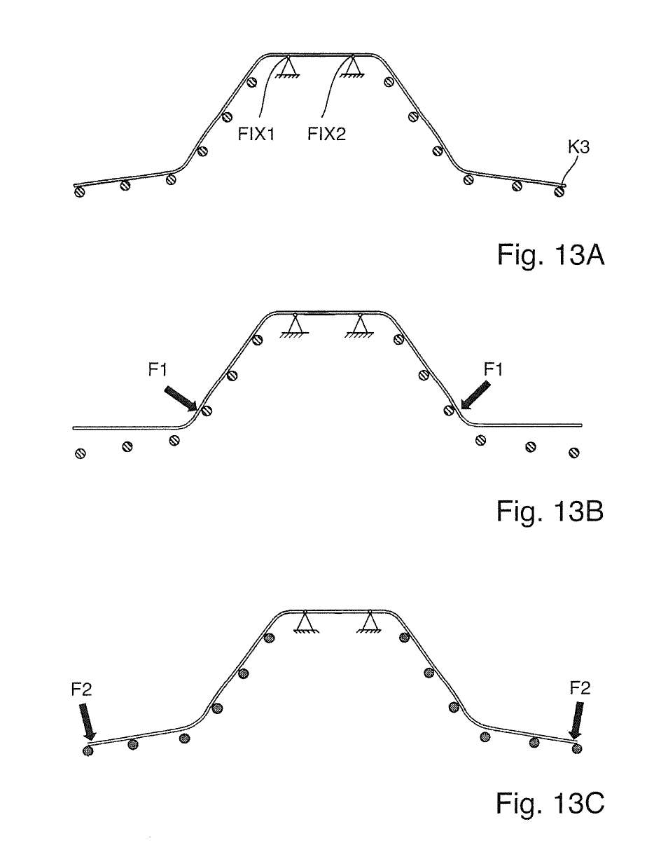

In the example of the hat profile from FIG. 12, the next steps of the simulation are now explained on the basis of the figures that follow. The overbending is produced by an iterative process. In this example, the forces F₁, F₂ and so on required for the overbending are applied simultaneously or sequentially to the geometry or configuration to be formed. Serving as orientation for the overbending in the example of FIG. 13 are (virtual) supporting elements SE produced on the basis of the correction geometry in accordance with the DA method, that is to say according to the third configuration K3, and placed (virtually) in space. Alternatively, the third configuration, that is to say the correction geometry in accordance with the DA method itself, may also be used for orientation.

FIG. 13A schematically shows supporting elements SE arranged at a mutual distance from one another and as a result form a supporting element grid, each supporting element representing a position on the target configuration (third configuration). One advantage of using supporting elements is that they make it possible for the correction geometry to be produced by deforming the zero or springback geometry (second configuration) without complex calculation of the required amounts and directions of the forces used for the deformation. The supporting elements serve as virtual “stop elements,” the deformation being ended locally when a supporting element is reached by the changing configuration.

FIGS. 13B and 13C show by way of example a sequential introduction of force for overbending the configuration until it lies against the supporting elements. In this example, starting from the fixing points FIX1, FIX2, first a force F₁ is applied in regions closer to the fixing points. After that, deformation forces are successively applied in force introduction regions further away such as, for example, the deformation force F₂ in the vicinity of the longitudinal edges of the hat profile (FIG. 13C).

Positioning the supporting elements for the simulation was performed in dependence on the displacement vector field of the springback and the component geometry. First, a suitable grid for the supporting elements was defined in dependence on the size of the component. We found to be expedient if any supporting elements at unsuitable regions of the component are subsequently removed. These may, for example, be component regions with great local curvatures (for example, as a result of embossings). In one variant, the definition/identification of these regions (not suitable for supporting elements) was performed on the basis of the angles between the displacement vectors. For this, a maximum permissible angle between adjacent displacement vectors was defined. At positions at which the maximum permissible angle was exceeded, no supporting element was provided or a supporting element actually provided in the grid was removed.

Once the zero geometry (first configuration) has been overbent by the displacements defined in the form of boundary conditions in the finite element software, the displacements of the nodes in the global system of coordinates and also the coordinates of the nodes associated with the displacements are read out from the finite element software. Subsequently, with the aid of CAD software, for example, CATIA® RSO, the active surfaces can be derived with the aid of the displacements and the coordinates. This makes it possible for the correction geometry produced to be output in an area format suitable for further use. In this way, an active surface or an active-surface geometry specification for the active surface of an actual forming tool can be determined, and this can then produce a complex formed part by performing a drawing type of forming process on a workpiece and the workpiece can be formed such that, after the forming, the desired target geometry is obtained within tolerances. If, after the first compensation, a component conforming to the required shape and dimensions (within the tolerances) is not obtained, at least one further compensation loop can be run through in accordance with the strategy set out here.

In the method presented here by way of example, the correction geometry is not produced by a strict geometrical inversion of the deviation vector field (as in the DA method), but by the springback geometry being approximated sufficiently well by suitable virtual application of force to the compensation geometry in accordance with the DA method. This virtual application of force may be implemented, for example, as an additional program module in suitable simulation software such as, for example, A UTOFORM®.

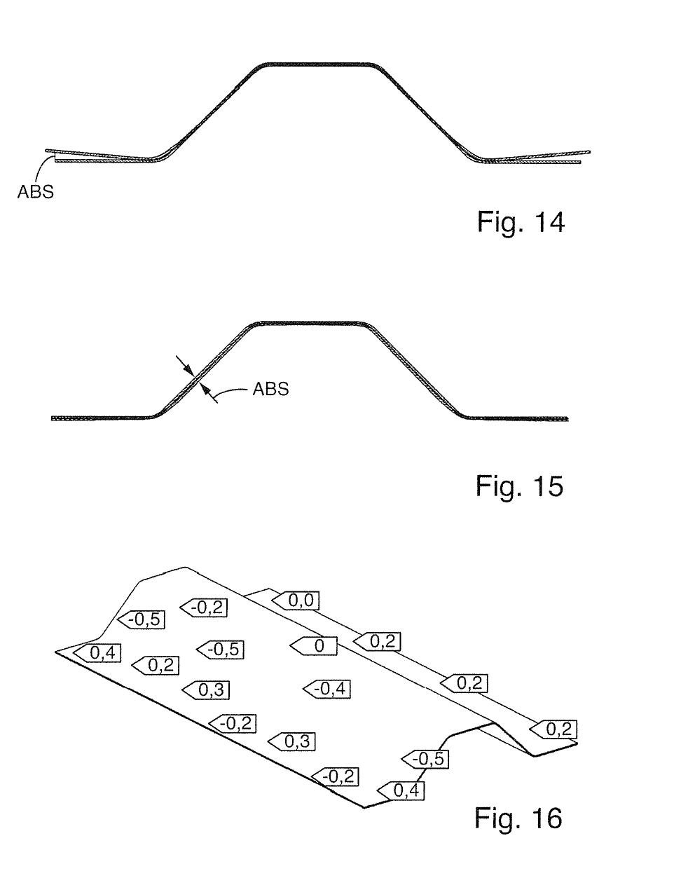

To allow a quantitative comparison with conventional methods, the workpiece W (hat profile) presented in connection with FIGS. 1 to 9 was formed by the method described above with the aid of virtual application of force. For illustrative comparison, FIG. 14 shows the result of the conventional method (according to FIG. 5) in a maximum orthogonal deviation ABS of about 4.2 mm in the vicinity of the longitudinal edges of the hat profile and a clearly evident development error. FIG. 15 shows in a comparable representation the distances between the configuration achieved and the configuration after the first geometrical compensation according to our method, while taking into account the stiffness of the workpiece. The region of maximum deviation thus lies in the sloping surfaces of the hat profile, where the maximum deviation (maximum perpendicular distance ABS) is still about 0.8 mm. The comparison of the distances in relation to the preset geometry after the first geometrical compensation therefore shows in this example a deviation that is about four times smaller compared to the conventional DA method.

On account of the still remaining error of about 0.8 mm, a further compensation loop according to our method was run through, while taking into account the stiffness of the workpiece. The result is shown in FIG. 16. After the second compensation loop, virtually all regions of the component satisfied the shape-related and dimensional requirements for connection areas and functional areas that are standard in bodywork construction of ±0.5 mm. FIG. 16 shows for some selected regions the local distance between the geometry achieved and the preset geometry after the second compensation loop.

The quantitative comparison on the basis of the maximum deviation in relation to the preset geometry demonstrates by way of illustration the achievable advantages of our method. With the conventional DA method, it was possible after the three iteration loops typically prescribed as standard for the distance in relation to the preset geometry to be reduced from originally about 13.8 mm to 0.7 mm. With our method, it is possible after two iteration loops for the distance in relation to the preset geometry to be reduced to a maximum of 0.5 mm so that there is no need for a third correction loop.

A comparison of the development lengths of the zero geometry (first configuration) to the correction geometry achieved after the first compensation loop likewise shows considerable improvements. The development length of the correction geometry (247.794 mm) differed from the development length of the zero geometry (247.984 mm) only by 0.08%. This remaining deviation is substantially attributable to the reconstruction of the geometry read out from the simulation software so that for practical purposes it can be assumed that the method provides the possibility that the components produced with it can be to the greatest extent equal in surface area, or are for all practical purposes equal in surface area, to the zero geometry desired for the component even in cases of relatively great springback.

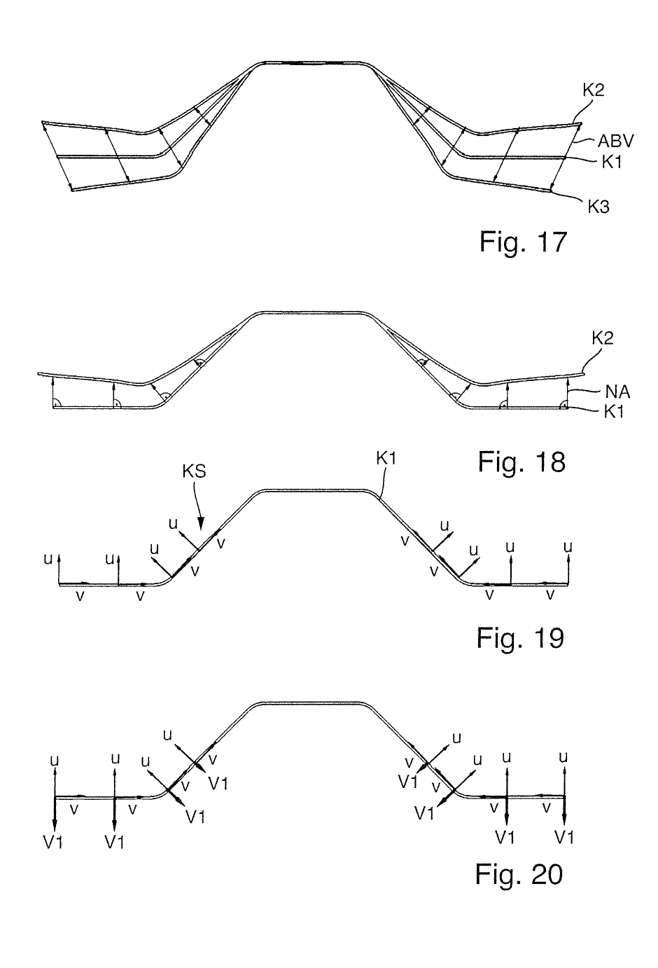

On the basis of FIG. 17, a displacement-based compensation approach is explained as a further example in which, unlike in the example above, no forces are used as boundary conditions in the finite element software for the calculation of the processes during overbending of the zero geometry. Instead, displacements are used, these being realized (in a way similar to the first example) while taking into account the stiffness of the component. Amounts, directions and application points of the displacements are derived on the basis of a displacement vector field of the springback. For the virtual “mounting” of the zero geometry or springback geometry at fixing points, the same concepts can be used as in the first example so that to avoid repetition reference is to this extent made to the description there (for example, in connection with FIGS. 11 and 12).

First, a calculation of the deviation vector field is performed (in the variant considered here) with deviation vectors ABV between mesh nodes of the first configuration K1 (zero configuration) and the assigned mesh nodes of the second configuration K2, that is to say the node displacement vector field of the springback in a way corresponding to the DA method. The coordinates of the associated nodes of the FE mesh from the forming simulation are read out. If there is no FE mesh, for example, in optical measurement of the springback geometry, the zero geometry (first configuration) and the springback geometry (second configuration) may first be described by an accumulation of topological points. FIG. 17 illustrates by way of example the node displacement vector field of the springback in a way analogous to FIG. 2.

The displacement vector field of the springback that uniquely defines the displacement of workpiece nodes or surface points in the space before and after the springback is used to calculate a vector field containing a multiplicity of vectors that are at selected locations of the first configuration perpendicular to the surface area defined by the first configuration K1. These vectors, aligned orthogonally in relation to the first configuration K1, are referred to here as normal deviation vectors NA. The associated vector field is the normal deviation vector field. FIG. 18 schematically shows normal deviation vectors NA of this normal deviation vector field perpendicular to the surface of the zero geometry.

A normal deviation vector may be calculated, for example, by decomposing a node displacement vector of the springback in that its component directed perpendicularly in relation to the first configuration is defined as the normal deviation vector. Normal deviation vectors may also be defined independently of positions of mesh nodes as normal vectors in relation to the first configuration at any other point.

In a next step, the required overbending of the zero geometry is simulatively calculated with the aid of finite element software on the basis of the read-out displacements of the normal deviation vector field. For this, local systems of coordinates KS are defined in the finite element software, a coordinate axis (in the example of FIG. 19 the u axis) respectively pointing in the direction of the local system of coordinates of the starting normal deviation vector of the springback, that is to say perpendicular to the surface of the first configuration K1 or zero geometry.

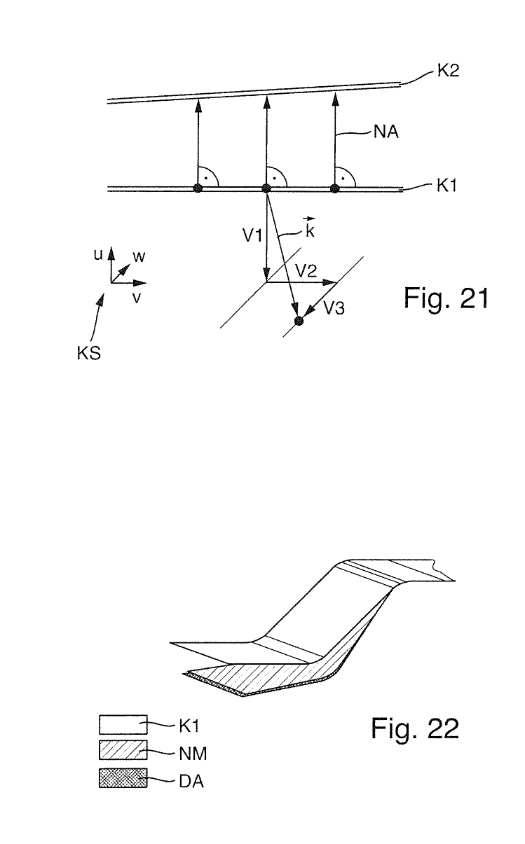

In a next step, at the positions of the local systems of coordinates KS, displacements are defined as boundary conditions in the finite element software. These displacements V₁ are specified in the opposite direction to the corresponding normal deviation vectors NA, but with an identical amount. FIG. 20 shows this method step schematically. Here, it is decisive that, in the calculation, i.e., in the finite element software concerned, these displacements V₁ are only defined in one direction of the local systems of coordinates. The two other directions are defined as free variables. Consequently, only a first component (here v₁) of a sought target displacement vector \vec{k}=(v₁, v₂, v₃) is specified, to be precise by geometrical inversion of normal deviation vectors NA of the normal deviation vector field with respect to the first configuration K1. FIG. 21 shows an illustrative representation of the sought target displacement vector \vec{k} and its components v₁, v₂, v₃ in the local system of coordinates KS on the basis of the normal deviation vectors NA of the normal deviation vector field between zero geometry (first configuration K1) and springback geometry (second configuration K2).

At this point, all necessary properties of the structure and boundary conditions of the geometry for the geometrically non-linear calculation (simulation) of the correction geometry or the target displacement vectors \vec{k} are defined. This includes the component geometry and all relevant characteristic material values. This gives a complete description of the stiffness of the workpiece. Furthermore, a component v₁ of the sought target displacement vector \vec{k} is prescribed. The components (v₂, v₃) still required for the unique definition of the sought target displacement vectors are obtained from the geometrically non-linear workpiece behavior, which can be taken into account by the stiffness matrix K as a function of the stress matrix K_{σ}, and also the first component v₁ from the solution of a non-linear system of equations of the finite element method. The Newton or Newton-Raphson method may be used, for example, for this. The components v₂ and v₃ are obtained as a result of the additional quadratic terms in the formulation of the Green-Lagrange strains in the non-linear FEM and the resultant addition to the stiffness matrix K of the stress matrix K_{σ}.

The functional principle of the second example is consequently also not a purely geometrical approach, but a physical approach since account is taken of the stiffness of the component in the calculation of the compensation. As a result, a high degree of area equality or development equality of the correction geometry achieved in relation to the zero geometry is ensured. On the basis of FIG. 22, a comparison of the development lengths of the zero geometry (first configuration K1) to the development lengths of the correction geometries in compensation according to the second example (light hatching NM) and the DA method (dark hatching DA) is presented. The zero geometry (first configuration K1) is characterized by a development length of 247.98 mm and a development length of the sloping portion of the hollow profile of 48.284 mm. In a compensation in accordance with the DA method, the values 253.839 mm and 50.012 mm are obtained that corresponds to a development error in the sloping portion of about 3.58%. By the novel method, an overall development length of 248.087 mm and in the sloping portion a development length of 48.32 mm are obtained that corresponds there to a development error of 0.074%. It is evident that this variant also leads to considerable improvements compared to the conventional DA method.

Once the zero geometry (first configuration K1) has been virtually overbent by the displacements defined in the form of boundary conditions in the finite element software, the displacements of the nodes in the global system of coordinates and also the coordinates of the nodes assigned to the displacements are read out from the finite element software. Subsequently, with the aid of CAD software, for example, CATIA® RSO the so-called CAD active surface can be derived with the aid of the displacements and the coordinates. The correction geometry thus produced is then defined as a tool geometry or as an active surface geometry specification for a renewed forming simulation—including springback simulation. If, after the simulation, a component conforming to the required shape and dimensions is not obtained, a further compensation loop can be run through in accordance with the strategy set out here.

1-11. (canceled)

12. A method of determining an active surface of a forming tool for producing a complex formed part with a target geometry by performing a drawing type of forming process on a workpiece comprising:
simulating a forming operation on the workpiece by a zero tool (NWZ) to produce a first configuration (K1) of the workpiece (W), the zero tool representing a forming tool having an active surface geometry corresponding to a desired target geometry of the workpiece;
simulating an elastic springback of the workpiece from the first configuration (K1) into a second configuration (K2) that is largely free of external forces, the simulation being performed based on an elastic-plastio material model of the workpiece;
calculating a deviation vector field with deviation vectors (ABV) between the first configuration (K1) and the second configuration (K2);
carrying out a non-linear structural-mechanical finite-element simulation on the workpiece, the workpiece being deformed by the non-linear structural-mechanical finite-element simulation from the first configuration or the second configuration into a target configuration by using deviation vectors (ABV) of the deviation vector field, wherein the following steps being carried out in the non-linear structural-mechanical finite-element simulation:
defining at least three fixing points (FIX1, FIX2, FIX3, FIX4) of the first configuration or the second configuration, the fixing points intended to remain unchanged with respect to their position during the non-linear structural-mechanical finite-element simulation;
fixing the first configuration (K1) or the second configuration (K2) at the fixing points;
approximating the configuration of the workpiece to the target configuration outside the fixing points by calculating forces or displacements while accounting for the stiffness of the workpiece until the target configuration is achieved; and
specifying the achieved target configuration as the active surface for the forming tool.

13. The method as claimed in claim 12, wherein the defining of fixing points (FIX1, FIX2, FIX3, FIX4) comprises:
selecting a regional or global adaptation region in which an adaptation between the first configuration (K1) and the second configuration (K2) is to be performed;
aligning the first configuration (K1) and the second configuration (K2) in relation to one another such that in the adaptation region there is a minimal geometrical deviation between the first configuration and the second configuration in accordance with a deviation criterion by the method of least squares; and
defining fixing points (FIX I, FIX2, FIX3, FIX4) at at least three selected positions with a local minimum of a deviation between the first configuration (K1) and the second configuration (K2).

14. The method as claimed in claim 13, wherein positions of fixing points (FIX1, FIX2, FIX3) are selected such that the fixing points form at least a triangular arrangement.

15. The method as claimed in claim 12, further comprising in the force-based simulation:
calculating the deviation vector field with deviation vectors between mesh nodes of the first configuration (K1) and assigned mesh nodes of the second configuration (K2);
calculating a third configuration (K3) inverse to the second configuration based on the deviation vector field, correction vectors (KV) being calculated from the deviation vectors by geometrical inversion with respect to the first configuration, and the third configuration (K3) being calculated by applying the correction vectors to mesh nodes of the first configuration (K1);
introducing deformation forces (F) into the workpiece in at least one force introduction region lying outside a fixing point to approximate the configuration of the workpiece to the third configuration (K3);
determining deformations of the workpiece under an effect of the deformation forces by the non-linear structural-mechanical finite-element simulation while accounting for the stiffness of the workpiece;
varying the deformation forces until the target configuration is achieved under elastic deformation; and
specifying the achieved target configuration as the active surface for the forming tool.

16. The method as claimed in claim 15, wherein the third configuration (K3) is defined by a supporting element grid with a multiplicity of supporting elements (SE) lying at a distance from one another, each supporting element representing a position on the target configuration.

17. The method as claimed in claim 15, further comprising simultaneously or sequentially introducing force at different force introduction regions until the configuration lies against a multiplicity of supporting elements (SE) under elastic deformation.

18. The method as claimed in claim 12, wherein the following steps are carried out in a displacement-based calculation:
calculating a deviation vector field with deviation vectors between the first configuration (K1) and the second configuration (K2) such that each deviation vector is a normal deviation vector (NA), which at a selected location of the first configuration is perpendicular to the first surface area defined by the first configuration at the location and connects the location to an assigned location of the second configuration (K2); and
calculating a target displacement vector field with a multiplicity of target displacement vectors (\vec{k}), each target displacement vector connecting a selected location of the first configuration (K1) to an assigned location of the target configuration, wherein
first components (v₁) of the target displacement vectors are prescribed by geometrical inversion of normal deviation vectors (NA) of the deviation vector field with respect to the first configuration and second and third components (v₂, v₃) of the target displacement vectors are calculated on the basis of the first components (v₁) by the non-linear structural-mechanical finite-element simulation while taking into account the stiffness of the workpiece.

19. The method as claimed in claim 12, further comprising at least one further non-linear structural-mechanical finite-element simulation on the workpiece after completion of a first non-linear structural-mechanical finite-element simulation with a compensated forming tool with an active surface according to a previous non-linear structural-mechanical finite-element simulation.

20. A method of producing a forming tool for producing a complex formed part with a target geometry by performing a drawing type of forming process on a workpiece, wherein the forming tool has an active surface that engages the workpiece to be formed comprising:
determining an active-surface geometry specification for the active surface according to the method of claim 12; and
producing the active surface according to the active-surface geometry specification.

21. A method of producing a complex formed part with a target geometry by performing a drawing type of forming process on a workpiece by using a forming tool having an active surface that engages the workpiece to be formed, comprising producing a forming tool according to the method as claimed in claim 20.

22. A non-transitory computer program product stored on a computer-readable medium or realized as a signal, the computer program product, when it is loaded into the memory of a suitable computer and executed by a computer, having the effect that the computer carries out the method as claimed in claim 12.
